(19) United States
(12) Patent Application Publication
(10) Pub. No.: US 2005/0213500 A1
(43) Pub. Date: Sep. 29, 2005

(54) Techniques to adaptively control flow thresholds

(76) Inventor: Dan Gaur, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/812,596

(22) Filed: Mar. 29, 2004

(51) Int. Cl. H04L 12/26

(52) U.S. Cl. 370/229

(57) ABSTRACT

Briefly, techniques to adaptively control flow thresholds.

### FIELD

The subject matter disclosed herein generally relates to techniques to manage bit receive rates.

### DESCRIPTION OF RELATED ART

IEEE standard 802.3x, Specification for 802.3 Full Duplex Operation (1997) describes an Ethernet “flow control” protocol. Flow control is a mechanism for preventing a network interface device from being overrun by transmitting “pause frames” (commonly called XOFF frames). When an Ethernet controller determines that the incoming frame rate may lead to buffer overflow, the Ethernet controller may send an XOFF frame to its link partner. The XOFF frame informs the link partner to not send traffic to the network interface device for some specified window of time. This delay allows the network interface device to process its backlog of traffic and free storage for subsequent traffic, thereby reducing the likelihood of dropping any incoming frames/packets. The controller may then explicitly send an XON frame to request resuming transmission.

One prior art technique commonly used by network drivers is for an inflow threshold value to be set to a worst-case level to avoid packet loss. However, this technique may not provide optimal inflow for all network interface device conditions such as where the network interface device can receive more traffic than permitted by the inflow threshold value. Another prior art technique is to set an inflow threshold value to a specific non-worst-case level. However, some network conditions may result in inflow packet loss and accompanying performance degradation. In addition, this technique also limits inflow when the network interface device can receive more traffic than permitted by the inflow threshold value. Techniques are needed to flexibly adjust inflow threshold rates.

### BRIEF DESCRIPTION OF THE DRAWINGS

FIG. 1 depicts an example environment in which some embodiments of the present invention may be used.

FIG. 2 depicts example formats of the XOFF signal.

FIG. 3 depicts an example implementation of the controller.

FIG. 4 depicts a flow chart in accordance with an embodiment of the present invention.

Note that use of the same reference numbers in different figures indicates the same or like elements.

### DETAILED DESCRIPTION

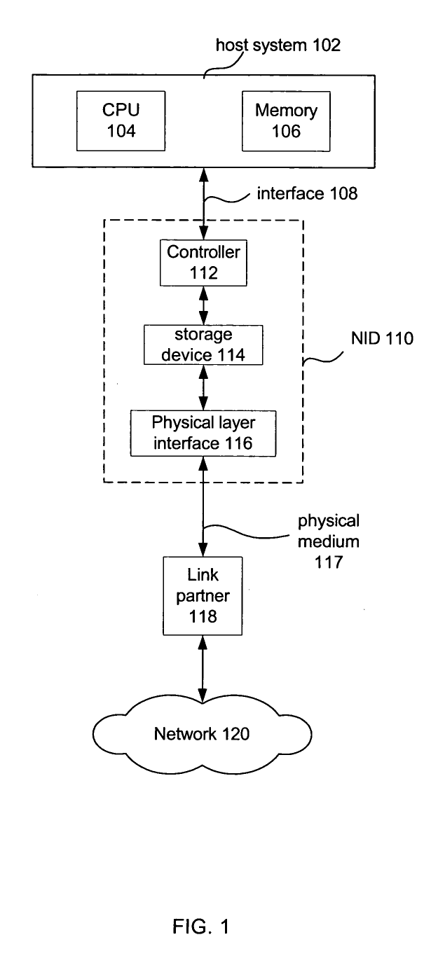

FIG. 1 depicts an example environment in which some embodiments of the present invention may be used. The system of FIG. 1 may include a host system 102, interface 108, network interface device (NID) 110, link partner 118, and network 120. One implementation of host system 102 may include a central processing unit (CPU) 104 and host memory 106. Host memory 106 may store applications, an operating system, and device drivers (not depicted).

Interface 108 may provide intercommunication between host system 102 and NID 110 as well as other devices such as a storage device (not depicted), and/or network cards (not depicted). Interface 108 may be compatible with Ten Gigabit Attachment Unit Interface (XAUI) (described in IEEE 802.3, IEEE 802.3ae, and related standards), universal serial bus (USB), IEEE 1394, Peripheral Component Interconnect (PCI) described for example at Peripheral Component Interconnect (PCI) Local Bus Specification, Revision 2.2, Dec. 18, 1998 available from the PCI Special Interest Group, Portland, Oreg., U.S.A. (as well as revisions thereof), PCI-x described in the PCI-X Specification Rev. 1.0a, Jul. 24, 2000, available from the aforesaid PCI Special Interest Group, Portland, Oreg., U.S.A. (as well as revisions thereof), ten bit interface (TBI), serial ATA described for example at “Serial ATA: High Speed Serialized AT Attachment,” Revision 1.0, published on Aug. 29, 2001 by the Serial ATA Working Group (as well as related standards), and/or parallel ATA (as well as related standards).

NID 110 may support multiple speeds of traffic transmitted bi-directionally between interface 108 and link partner 118. With respect to traffic from link partner 118 to NID 110, in one implementation, NID 110 may control when traffic is transmitted by link partner 118 to NID 110. With respect to traffic from interface 108 to NID 110, controller 112 may not fetch traffic from interface 108 unless it has enough internal storage. One implementation of NID 110 may include controller 112, storage device 114, and physical layer interface 116. NID 110 may be implemented as any or a combination of hardwired logic, software stored by a memory device and executed by a microprocessor, firmware, an application specific integrated circuit (ASIC), and/or a field programmable gate array (FPGA).

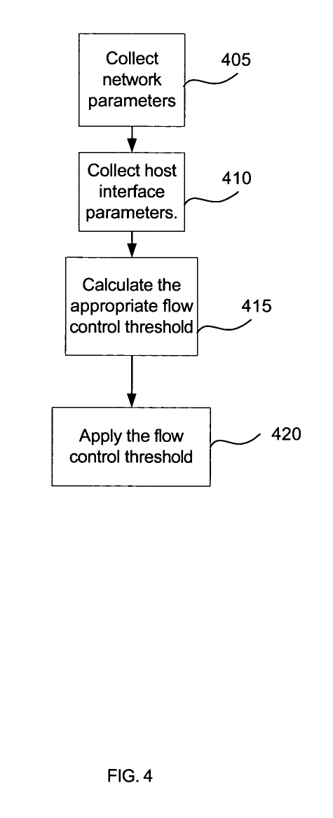

Controller 112 may determine a storage threshold of storage device 114. For example, controller 112 may utilize a process described with respect to FIG. 4 to determine a storage threshold for storage device 114. With respect to traffic from link partner 118, when controller 112 determines that the stored content of storage device 114 exceeds the threshold, controller 112 may initiate transmission of an XOFF frame to its link partner (e.g., link partner 118). The XOFF frame informs the link partner to stop sending frames to NID 110 for a specified window of time. Controller 112 may thereafter explicitly send an XON signal to request the link partner to resume frame transmission, or link partner 118 may allow the delay period specified in the XOFF frame to expire, at which point the link partner 118 could re-commence traffic transmission to NID 110. In one implementation, controller 112 may transmit XOFF and XON signals to link partner 118 by placing XOFF and XON signals into storage device 114 for transmission through physical layer interface 116 to link partner 118.

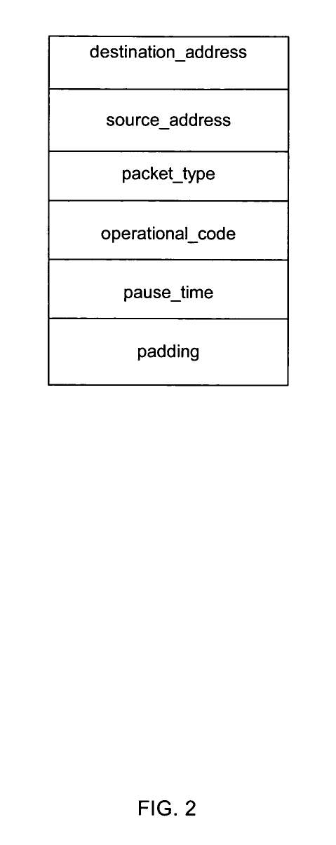

For example, FIG. 2 depicts example formats of an XOFF frame. For example, the XOFF frame includes the fields of destination_address, source_address, packet_type, operational_code, pause_time, and padding. For example, field destination_address may represent the address of link partner 118. For example, field source_address may represent the address of NID 110. The field packet_type identifies the format and layout of data within the packet. For example, flow control packets have a packet_type of 0x8808, while IP packets have a packet_type of 0x800. For example, field operational_code may indicate that a pause operation is to take place. For example, field pause_time represents a time for the link partner 118 to pause sending packets to NID 110. For example, field padding may be filled with zeros. In one implementation, an XOFF frame may be seventy-two (72) bytes.

In one implementation, controller 112 may re-calculate the threshold value periodically as its environment changes. One example of an environment change is when the physical medium 117 is unplugged, then re-connected to a link partner of different speed. Another example of an environment change is a change of the type or length of physical medium 117. Such changes could potentially change factors such as (a) link speed of network 120, (b) signal propagation speed through physical medium 117, and/or (c) length of physical medium 117. In one embodiment, a user could trigger an update of the threshold value by changing some of configuration parameters such as (a) link speed of physical medium 117 and (b) maximum frame size transmitted by network 120. Other changes may trigger re-calculation of the threshold value.

Controller 112 may also perform medium access control (MAC) processing of data in compliance with Ethernet as well as IEEE 802.3x. For example, controller 112 may add the framing bytes (e.g., Ethernet preamble, start-of-frame delimiter and CRC) to Ethernet compliant packets from host system 102.

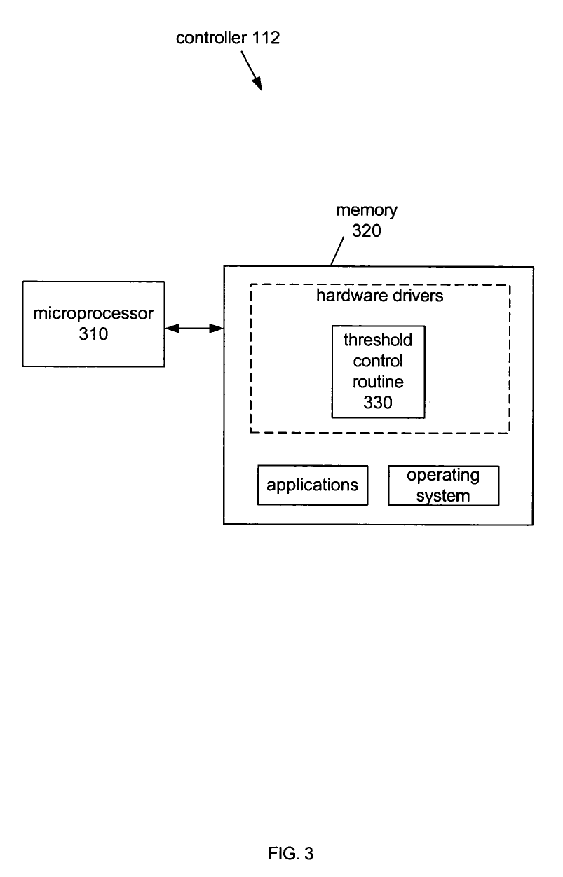

For example, FIG. 3 depicts an example implementation of controller 112. Controller 112 may include microprocessor 310 and memory 320. Memory 320 may store an operating system, applications, and device drivers such as a threshold control routine 330.

Storage device 114 may include a linear bi-directional queue for transferring data and information between interface 108 to physical medium 117 and vice versa. Storage device 114 may store traffic received from link partner 118 as well as traffic received from interface 108. For example, storage device 114 may be implemented as a flash memory device. Controller 112 may utilize direct memory access (DMA) techniques to transfer traffic from storage device 114 to host system 102 and vice versa. Controller 112 may control the location in storage device 114 in which traffic is stored. Controller 112 may monitor the storage capacity of storage device 114.

In one implementation, to provide intercommunication between storage device 114 and physical layer interface 116, interfaces compatible with the following standards may be used: a Gigabit Media Independent Interface (GMII) (described in IEEE 802.3, IEEE 802.3ae, and related standards) or Ten Gigabit Media Independent Interface (XGMII) compatible interface (described for example in IEEE 802.3ae).

Physical layer interface 116 may interface storage device 114 with the physical medium 117. Physical medium 117 may provide intercommunication between physical layer interface 116 and link partner 118. For example, physical medium 117 may be implemented using a 10GBase-LR link or 10GBase-SR link (although other physical links may be used).

Link partner 118 may provide intercommunication between NID 110 and network 120. Link partner 118 may be implemented as a switch or a hub that transfers traffic transmitted in accordance with Ethernet (described in IEEE 802.3 and related standards).

Network 120 may be any network such as the Internet, an intranet, a local area network (LAN), storage area network (SAN), a wide area network (WAN), or wireless network. Network 120 may utilize any communications standards. Network 120 may receive and provide packets encapsulated according to Ethernet as described in versions of IEEE 802.3.

FIG. 4 depicts a flow chart of a process to determine a storage threshold of storage device 114 in accordance with an embodiment of the present invention. Action 405 may include collecting the relevant network parameters such as the (1) link speed of network 120 (in bits/second) (hereafter “LS”), (2) signal propagation speed of the physical medium 117 (in meters/second) (hereafter “PS”), (3) length of the physical medium 117 (in meters) (hereafter “L”), and (4) maximum frame size of packets transmitted from link partner 118 to NID 110 (in bytes) (hereafter “F”). For example, the link speed of network 120 may be monitored by physical layer interface 116. The signal propagation speed of physical medium 117 may be based on the type of physical medium used. For example if physical medium 117 is fiber optic cable, then the signal propagation speed of physical medium 117 is the speed of light through fiber optic cable. For example if physical medium 117 is copper cable, then the signal propagation speed of physical medium 117 is the speed of electrons through copper cable. The length of physical medium 117 may be monitored by a device driver of the NID 110. For example, physical layer interface 116 may determine the length of physical medium 117 using known techniques such reflection of a test signal transmitted through physical medium 117 and such factors as signal attenuation through the medium, output levels of the remote transceiver, and connector impedance. The maximum frame size of network packets is based on the transmission protocols utilized (e.g., Ethernet).

Action 410 may include collecting the relevant host device interface parameters such as bus speed and width of interface 108. Bus speed may be measured in cycles per second (Hz) of interface 108 (hereafter “BS”). Width refers to the amount of bits that can be transmitted through interface 108 in a single cycle (measured in bits) (hereafter “BW”). For example, controller 112 may determine bus speed and width of interface 108.

Action 415 may include determining the appropriate flow control threshold to apply to storage device 114. For example action 415 may determine the threshold using the following relationship:
Flow control threshold=(Total capacity of storage device 114)−(safety margin), where
(1) Total capacity of storage device 114 is the total storage capacity of storage device 114 to store traffic from link partner 118; and
(2) Safety margin may be expressed as:
   (a) amount of bits that might arrive to NID 110 from link partner 118 while controller 112 locally prepares the XOFF frame for transmission +
   (b) amount of bits that might arrive to NID 110 from link partner 118 while the XOFF frame is in transit from NID 110 to link partner 118 +
   (c) amount of bits that might arrive to NID 110 from link partner 118 while link partner 118 processes the XOFF frame +
   (d) amount of bits that link partner 118 might have transmitted to NID 110 while link partner 118 processes the XOFF frame −
   (e) amount of bits that have been drained from storage device 114 during performance of (a) through (d).

The amount of bits that might arrive to NID 110 from link partner 118 while controller 112 locally prepares the XOFF frame for transmission may include a sum of: (i) bits that arrive to NID 110 from link partner 118 while controller 112 recognizes capacity of storage device 114 has exceeded a threshold and controller 112 prepares the outgoing XOFF frame; (ii) total bits in any currently-transmitted packets from link partner 118 to NID 110 to be completely received by NID 110; and (iii) standard Ethernet inter-packet gap (IPG) (in bits). An Ethernet device leaves at least an IPG-worth of space between successive transmitted packets. The IPG affects how much packet data can physically be transmitted/received in any fixed period of time. In Ethernet, the IPG is 12 bytes. In one implementation, the amount of bits that might arrive to NID 110 from link partner 118 while controller 112 locally prepares the XOFF frame for transmission may be represented as:
LS*pd+(F*8)+(IPG*8), where
LS=link speed of network 120 (in bits/second);
pd=delay to prepare the XOFF frame at the NID 110, in seconds. This may vary between different implementations of NID 110, but can be a constant for a specific implementation of NID 110; and
F=maximum frame size of network packets exchanged between NID 110 and link partner 118 (in bytes).

The amount of bits that might arrive to NID 110 from link partner 118 while the XOFF frame is in transit from NID 110 to link partner 118 may include the sum of: (i) bits that arrive to NID 110 from link partner 118 while NID 110 places contents of the XOFF frame on physical medium 117 and (ii) bits that arrive to NID 110 from link partner 118 while the first bit of the XOFF propagates through the physical medium and reaches link partner 118. The amount of bits that might arrive to NID 110 from link partner 118 while the XOFF is in transit from NID 110 to link partner 118 may be represented as:
(xs*8)+(L/PS)*LS, where
xs=size of the XOFF frame in bytes (e.g., 72 bytes);
L=length of the physical medium (in meters); and
PS=signal propagation speed of the physical medium (in meters/second).

The amount of bits that might arrive to NID 110 from link partner 118 while link partner 118 processes the XOFF frame may include bits that arrive to NID 110 during the maximum time allowed for XOFF frame processing, as specified by the IEEE 802.3x specification. The amount of bits that might arrive to NID 110 from link partner 118 while link partner 118 processes the XOFF frame may be represented by:
N*pq, where
N=a constant based on the speed of the protocol. For 10 Gigabit Ethernet, N is 60 and for 1 Gigabit Ethernet, N is 2, although other protocols and speeds may be used.
pq=Ethernet pause quantum (e.g., 512 bits)

The amount of bits that link partner 118 might have transmitted to NID 110 while link partner 118 processes the XOFF frame may include the sum of: (i) bits that arrive to NID 110 while link partner 118 places the contents of its last packet after processing the XOFF frame on physical medium 117 and (ii) bits that arrive to NID 110 from link partner 118 while the first bit of the XOFF frame propagates through physical medium 117 and reaches controller 112. The amount of bits that link partner 118 might have transmitted to NID 110 while link partner 118 processes the XOFF frame may be represented as:
(F*8)+(L/PS)*LS, where
F=maximum frame size of network packets exchanged between NID 110 and link partner 118 (in bytes);
L=length of physical medium 117 (in meters);
PS=signal propagation speed of physical medium 117 (in meters/second); and
LS=link speed of network 120 (in bits/second).

The amount of bits drained from storage device 114 during performance of (a) through (d) may be the product of (i) speed of interface 108; (ii) width of interface 108; and (iii) percent utilization of interface 108. The amount of bits drained from storage device 114 during performance of (a) through (d) may be represented as:
(BS*BW*bu)*(Total Incoming Data/LS), where
BS=speed of interface 108 (Hz);
BW=amount of bits that can be transmitted through interface 108 in a single cycle (bits);
bu=bus utilization, which is an estimate of how much of the capacity of interface 108 can be used to drain storage device 114. This can be estimated as between 40% to 60%;
Total Incoming Data=sum of step (a) through step (d) (bits); and
LS=link speed of network 120 (bits/second).

Action 420 may include the controller 112 applying the determined flow control threshold.

The drawings and the forgoing description gave examples of the present invention. While a demarcation between operations of elements in examples herein is provided, operations of one element may be performed by one or more other elements. The scope of the present invention, however, is by no means limited by these specific examples. Numerous variations, whether explicitly given in the specification or not, such as differences in structure, dimension, and use of material, are possible. The scope of the invention is at least as broad as given by the following claims.

1. A method comprising:
determining network parameters;
determining host interface parameters;
setting a storage threshold capacity of a storage device based on at least one network parameter and at least one host interface parameter; and
transmitting a request to stop transmission of traffic to the storage device based the storage device exceeding the storage threshold capacity.

2. The method of claim 1, further comprising adjusting the storage threshold capacity based on changes to a network parameter.

3. The method of claim 1, further comprising adjusting the storage threshold capacity based on changes to a host interface parameter.

4. The method of claim 1, wherein the network parameter includes at least one of the following:
link speed of a network that transmits traffic to the storage device;
signal propagation speed of a physical medium that transfers traffic from the network to the storage device;
length of the physical medium that transfers traffic; and
maximum frame size of packets in the traffic.

5. The method of claim 1, wherein the host interface parameter comprises any of a local bus speed and number of bits that can be transmitted through the bus in a single cycle.

6. The method of claim 1, wherein the storage threshold capacity comprises a difference between total storage capacity of the storage device to store traffic from a link partner and a safety margin and wherein the safety margin comprises:
(i) amount of bits that might be transmitted from the link partner while the request to stop transmission of traffic is prepared +
(ii) amount of bits that might be transmitted from the link partner while the request to stop transmission of traffic is in transit to the link partner +
(iii) amount of bits that might arrive to the storage device from the link partner while the link partner processes the request to stop transmission of traffic +
(iv) amount of bits that the link partner might have transmitted while the link partner processes the request to stop transmission of traffic −
(v) amount of bits drained from the storage device during (i) through (iv).

7. The method of claim 1 further comprising transmitting a request to allow transmission of traffic.

8. An apparatus comprising:
a storage device to store received traffic; and
a controller to manage the transmission of traffic to the storage device, wherein the controller is configured to:
determine at least one network parameter;
determine at least one host interface parameter;
set a storage threshold capacity of the storage device based on at least one network parameter and at least one host interface parameter;
monitor storage conditions of a storage device; and
transmit a request to stop transmission of traffic based on the storage device exceeding the storage threshold capacity.

9. The apparatus of claim 8, further comprising a physical layer interface to transfer received traffic to the storage device.

10. The apparatus of claim 8, wherein the controller is further configured to perform media access control processing in compliance with IEEE 802.3x.

11. The apparatus of claim 8, wherein the controller is configured to adjust the storage threshold capacity based on changes to a network parameter.

12. The apparatus of claim 8, wherein the controller is configured to adjust the storage threshold capacity based on changes to a host interface parameter.

13. The apparatus of claim 8, wherein the network parameter includes at least one of the following:
link speed of a network that transmits traffic to the storage device;
signal propagation speed of a physical medium that transfers traffic from the network to the storage device;
length of the physical medium that transfers traffic; and
maximum frame size of packets in the traffic.

14. The apparatus of claim 8, wherein the host interface parameter comprises any of a local bus speed and number of bits that can be transmitted through the bus in a single cycle.

15. The apparatus of claim 8, wherein the storage threshold capacity comprises a difference between total storage capacity and a safety margin and wherein total storage capacity of the storage device comprises the total storage capacity of the storage device to store traffic from a link partner and wherein the safety margin comprises:
(i) amount of bits that might be transmitted from the link partner while the request to stop transmission of traffic is prepared +
(ii) amount of bits that might be transmitted from the link partner while the request to stop transmission of traffic is in transit to the link partner +
(iii) amount of bits that might arrive to the storage device from the link partner while the link partner processes the request to stop transmission of traffic +
(iv) amount of bits that the link partner might have transmitted while the link partner processes the request to stop transmission of traffic −
(v) amount of bits drained from the storage device during (i) through (iv).

16. A system comprising:
a host system comprising a processor and a memory;
an interface;
a network interface device, the network interface device comprising:
a storage device to store received traffic; and
a controller to manage the transmission of traffic to the storage device, wherein the controller is configured to:
determine at least one network parameter;
determine at least one host interface parameter;
set a storage threshold capacity of the storage device based on at least one network parameter and at least one host interface parameter;
monitor storage conditions of a storage device; and
transmit a request to stop transmission of traffic based on the storage device exceeding the storage threshold capacity.

17. The system of claim 16, wherein the interface is compatible with PCI.

18. The system of claim 16, wherein the interface is compatible with PCI-x.

19. The system of claim 16, further comprising a storage device coupled to the interface.
